(19) United States
(12) Patent Application Publication
(10) Pub. No.: US 2025/0078351 A1
(43) Pub. Date: Mar. 6, 2025

(54) GENERATING A SERIES OF CONTEXTUALLY-PERSISTENT VISUAL IMAGES FOR TEXT DOCUMENTS UTILIZING MULTIPLE MODELS

(71) Applicant: Microsoft Technology Licensing, LLC, Redmond, WA (US)

(72) Inventors: Charan Kumbakonam MOHAN, Bengaluru (IN); Parag AGRAWAL, Bengaluru (IN); Sourabh MAITY, Hyderabad (IN)

(21) Appl. No.: 18/462,114

(22) Filed: Sep. 6, 2023

(51) Int. Cl. G06T 11/60; G06F 40/166; G06F 40/289; G06F 40/30

(52) U.S. Cl. CPC G06T 11/60; G06F 40/166; G06F 40/289; G06F 40/30

(57) ABSTRACT

This disclosure presents an image generation system designed to generate a series of contextually-persistent visual images for a text document. For instance, the image generation system utilizes multiple computer-based models, entity identifiers, and visual entity embeddings to create multiple synthetic images for a given text document. These synthetic images share a consistent theme and style. Additionally, the synthetic images include the same characters, places, and objects. Indeed, the image generation system implements seamless and consistent visual representations of the entities throughout the text document.

### BACKGROUND

In recent years, remarkable advancements in hardware and software have revolutionized the provision and consumption of digital content. The proliferation of mobile devices has granted users access to an abundance of resources and information through the Internet and Internet-based applications. Additionally, the advent of word processing and text rendering applications has empowered users to easily create and consume digital content. However, a considerable portion of available content is still presented primarily as text, lacking visual images or illustrative narratives that aid comprehension and context retention. Further, current computer systems fall short in their ability to generate and provide sets of context-related digital images for a text document. This technological gap impairs the potential to enhance the understanding and engagement of users by visually augmenting textual content, depriving them of a more immersive and enriching digital experience.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an overview example of implementing an image generation system that generates a series of contextually-persistent visual images for a text document utilizing multiple computer-based models.

FIG. 2 illustrates a system environment where an image generation system is implemented.

FIG. 3 illustrates a block diagram of various components of the image generation system.

FIG. 4 illustrates a sequence flow diagram example of a series of contextually-persistent visual images for a text document.

FIG. 5 illustrates a block diagram example of determining a visual entity embedding from a synthetic image.

FIGS. 6A-6B illustrate graphical user interfaces for adding contextually-persistent synthetic images to a text document.

FIG. 7 illustrates an example series of acts in a computer-implemented method for generating a series of contextually-persistent visual images for a text document utilizing multiple computer-based models.

FIG. 8 illustrates components included within an example computer system for implementing the image generation system.

### DETAILED DESCRIPTION

The present disclosure describes an image generation system that efficiently, accurately, and flexibly generates a series of contextually-persistent visual images for a text document. For instance, the image generation system leverages various computer-based models, entity identifiers, and visual entity embeddings to automatically create multiple synthetic images for a text document. The resulting synthetic images exhibit a continuous theme and style and also include the same characters, places, and objects. While the image generation system primarily functions to automatically produce an image series for a text document, the image generation system also has the capability to generate additional matching images in response to user interactions.

To illustrate this concept at a high level, consider a user reading a story or a subject-dense textbook without sufficient illustrations. The image generation system ingests the text (for example, a text document) and identifies entities (e.g., people, places, objects, concepts) to determine key passages throughout the document. Based on this analysis, the image generation system generates a set of images corresponding to these salient portions of the text, where the images maintain the same visual style, themes, characteristics, objects, places, and concepts across the set. As a result, the image generation system visually supplements and enhances the user's reading experience of text documents by visually complementing the text.

On a more technical level, consider a text document without accompanying images. In various implementations, the image generation system analyzes the text document to determine a set of entities, which are assigned entity identifiers. In addition, the image generation system separates the text into a set of semantic text chunks (e.g., identifies the set of semantic text chunks from the text document) and incorporates entity identifiers into the text chunks next to their corresponding entities. Then, for a first text chunk, the image generation system generates a first synthetic image utilizing the first text chunk and a first entity identifier associated with a first entity within the first text chunk. From the first synthetic image, the image generation system determines a first visual entity embedding and associates it with the first entity identifier.

For a second text chunk, the image generation system generates a second synthetic image utilizing the second text chunk, the first synthetic image, and the first entity identifier, which now includes the first visual entity embedding. This way the second synthetic image matches the style and look of the first synthetic image. The image generation system may repeat this process for additional synthetic images using previously generated synthetic images (e.g., based on some or all of the previously generated synthetic images) and visual entity embeddings to persist in the various contexts through the series of generated images.

As described in the following paragraphs and further below, the image generation system delivers several significant technical benefits in terms of computing efficiency, accuracy, and flexibility compared to existing systems. Moreover, the image generation system provides several practical applications that address problems relating to generating sets of synthetic images.

As mentioned above, the image generation system identifies entities included in a text document. Additionally, the image generation system generates and stores visual entity embeddings for various entities, which are later used when an entity is re-created in a synthetic image. By storing and reusing visual entity embeddings, the image generation system efficiently reduces the computing resources needed to generate synthetic images. This efficiency savings is magnified in longer text documents, which commonly include a larger number of synthetic images that include the same entity.

Additionally, the image generation system may also determine and store characteristics and attributes of an entity, which may be stored as sub-entities. The image generation system may use the visual entity embedding of an entity to more efficiently generate a corresponding sub-entity. Then, as above, the image generation system determines, stores, and re-uses the visual entity embedding for the sub-entity in future generated images to capitalize on efficiency gains.

As mentioned earlier, the image generation system provides accuracy gains over existing systems. As one example, the image generation system determines a set of entities and semantic text chunks for a text document by analyzing the text document as a whole to maintain contextual consistency for entities across text chunks. By considering the text as a whole, the image generation system more accurately generates entities and corresponding sub-entities that are used throughout the text.

As another example, by using visual entity embeddings, the image generation system generates a set or series of synthetic images for a text document that accurately persists contexts throughout the text document. Indeed, once an initial image is generated that includes an entity, the integrity of the entity is maintained throughout the set of synthetic images. This concept also applies to the themes, concepts, and styles used throughout a set of synthetic images generated for a text document.

Moreover, the image generation system provides flexibility over existing systems by providing tools and features to generate a series of contextually-persistent visual images for a text document. Additionally, the image generation system provides flexibility in automatically generating a series of contextually-persistent images for a text document and also allows additional or new synthetic images to be generated for the text document.

This disclosure uses several terms to describe the features and benefits of one or more implementations. As an example, a “text document” refers to a digital file and/or digital content that includes text organized and stored in a structured, human-readable format. Often, a text document does not include accompanying images. However, in some instances, a text document may include or be associated with one or more images.

As an example, a “semantic text chunk” refers to a sub-portion of a text document that includes a specific idea, concept, or piece of information. In many instances, two adjacent semantic text chunks semantically diverge from one another by a semantic threshold distance or amount. Examples of semantic text chunks include one or more lines, sentences, paragraphs, pages, sections, or chapters. In various instances, a semantic text chunk is a self-contained unit that contributes to the overall semantic structure and understanding of the document, often representing a distinct topic, entity, or relationship between entities.

As another example, an “entity” refers to a specific item, object, concept, or person mentioned or discussed within a text document. An entity can be a proper noun, such as a person's or company's name, or it can be a common noun that represents a distinct entity within the document's content. The image generation system can identify and generate unique entity identifiers for entities in a text document. Entities are commonly stored in an entity table or database.

Similarly, a “sub-entity” refers to a characteristic or attribute of an entity and is associated with the entity. An entity can include one or more sub-entities. In various instances, a sub-entity is assigned its entity identifier and/or a sub-entity identifier based on the entity identifier of its parent entity. In some instances, a sub-entity corresponds to a verb, adverb, or adjective of an entity (e.g., a sad person or a tall chair, where “sad” and “tall” are sub-entities for the entities of person and chair, respectively).

The image generation system generates synthetic images based on a semantic text chunk that includes one or more entities. As an example, a “synthetic image” refers to a computer-generated visual representation that is generated using models and/or algorithms. In many implementations, the image generation system generates a synthetic image by utilizing information extracted from a text chunk and its associated entities to construct an image that visually depicts the content, concepts, or relationships described within the text chunk. A synthetic image includes visual depictions of entities within an input text chunk.

As another example, a “visual entity embedding” refers to a numerical representation or vector that captures the visual features and characteristics of an entity within a synthetic image. A visual entity embedding, often generated by an image generation model through a deep-learning process, encodes relevant visual information such as colors, shapes, textures, or object attributes into a compact and meaningful representation. Visual entity embeddings allow the image generation system to efficiently and accurately generate, process, compare, and analyze additional visuals for entities in synthetic images.

As another example, “contextually-persistent visual images” refers to digital images that share one or more common contexts across the set of images for a text document. For example, entities in contextually-persistent visual images share a common appearance and likeness across the set of images. Additionally, contextually-persistent visual images for a text document maintain the same visual style, themes, characteristics, objects, places, and concepts across the set.

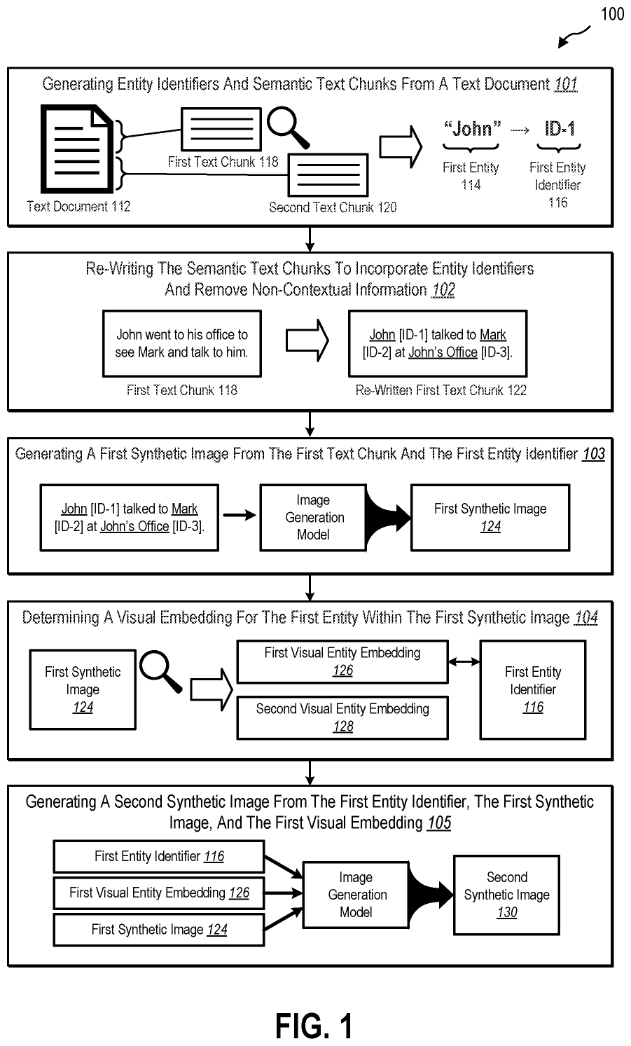

Further details regarding an example implementation of the image generation system are discussed in connection with the following figures. For example, FIG. 1 provides an overview example of implementing an image generation system that generates a series of contextually-persistent visual images for a text document utilizing multiple computer-based models according to some implementations. As shown, FIG. 1 includes a series of acts 100 performed directly or indirectly by the image generation system. FIG. 1 also shows various elements, features, and components associated with the image generation system including a text document 112 and an image generation model. Additionally, the image generation system utilizes various computer-based models and algorithms to perform some of the described acts.

As previously mentioned, the image generation system generates a series or set of images for a text document where all of the images in the set share a common theme and style. Additionally, entities within the set of images are constant and continuous throughout. In various instances, the image generation system ties common entities and visual entity embeddings to text identifiers to improve efficiency and accuracy throughout a set of synthetic images.

As shown, the series of acts 100 in FIG. 1 includes the act 101 of generating entity identifiers and semantic text chunks from a text document. For example, the image generation system ingests a text document and analyzes it as a whole to determine entities and sub-entities. The image generation system generates a set of entity identifiers for the determined entities. Additionally, the image generation system separates or partitions the document into semantic text chunks.

To illustrate, the act 101 shows a text document 112 being analyzed to determine a first entity 114 (i.e., “John”) and assigning a first entity identifier 116 to the first entity 114. Additionally, the text document 112 is analyzed to generate a first text chunk 118 and a second text chunk 120. While not shown in the act 101, the first text chunk 118 and the second text chunk 120 can each include an instance of the first entity 114.

As shown, the series of acts 100 includes the act 102 of re-writing the semantic text chunks to incorporate entity identifiers and remove non-contextual information. For instance, the image generation system re-characterizes each semantic text chunk to supplement and/or replace entities with their corresponding entity identifier. This way, the image generation system signals to downstream models the presence of entities within text chunks.

Additionally, in various instances, the image generation system re-writes text chunks to remove unnecessary phrases or information while still maintaining the text chunk as a complete story. In some instances, re-writing includes removing non-contextual information, including co-reference resolution. As shown, the act 102 includes an example of the image generation system re-writing the first text chunk 118 into a re-written first text chunk 122.

The series of acts 100 also includes the act 103 of generating a first synthetic image from the first text chunk and the first entity identifier. For instance, the image generation system provides each text chunk to an image generation model to generate a synthetic image. In various instances, the image generation model focuses on the entity identifiers within a text chunk when generating synthetic images. As shown, the image generation model generates a first synthetic image 124 from the re-written first text chunk 122.

As shown, the series of acts 100 includes the act 104 of determining a visual entity embedding for the first entity within the first synthetic image. In various instances, the image generation system determines visual entity embeddings for entities within synthetic images. For example, when the first synthetic image 124 includes the first entity and the second entity, the image generation system determines a first visual entity embedding 126 and a second visual entity embedding 128 for the first synthetic image 124. As also shown, the image generation system associates the first visual entity embedding 126 with the first entity identifier 116.

The series of acts 100 also includes the act 105 of generating a second synthetic image from the first entity identifier, the first synthetic image, and the first visual entity embedding. For instance, when generating a synthetic image for a text chunk that includes a previously referenced text identifier, the image generation system utilizes its stored visual entity embedding to create the entity in the new image to match. Further, the image generation system utilizes previously generated synthetic images to efficiently and accurately ensure continuity between images when creating the set of images. As shown, the image generation system utilizes the image generation model to generate a second synthetic image 130 using the first entity identifier 116 associated with the first visual entity embedding 126 and the first synthetic image 124.

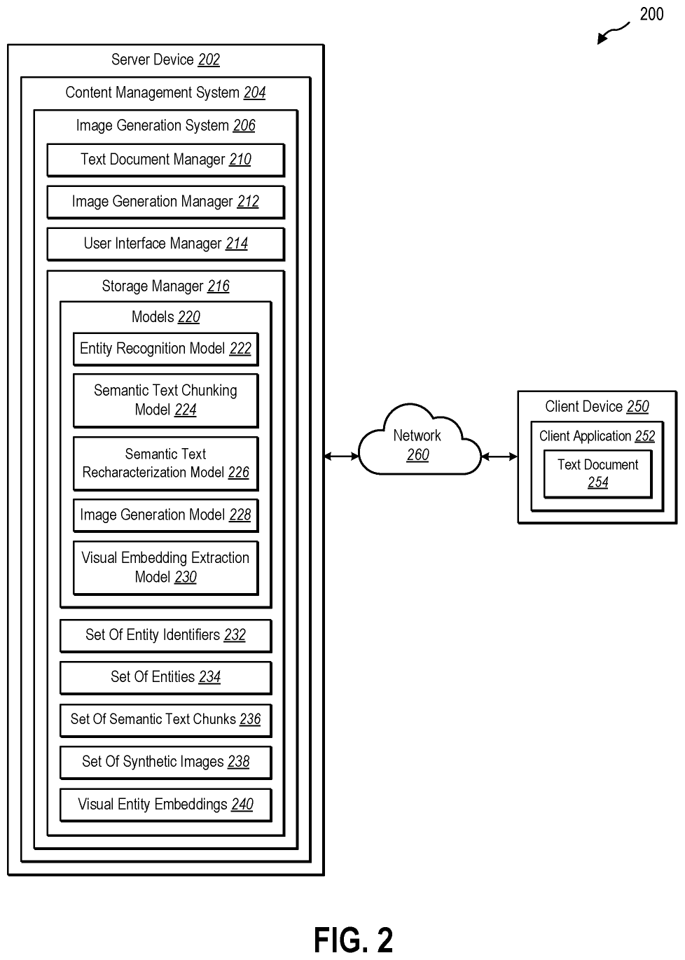

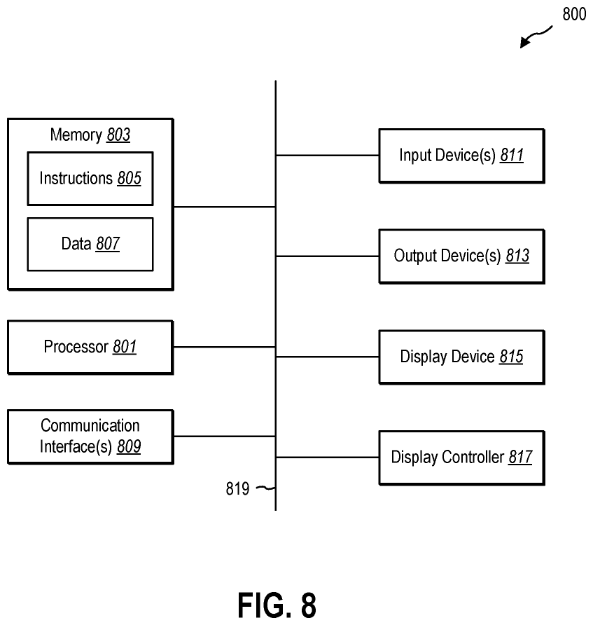

With a general overview of the image generation system in place, additional details are provided regarding the components, features, and elements of the image generation system. To illustrate, FIG. 2 shows an example system environment where an image generation system is implemented. In particular, FIG. 2 illustrates an example of a computing environment 200 that includes a server device 202 and a client device 250 connected via a network 260. Further details regarding these and other computing devices are provided below in connection with FIG. 8. In addition, FIG. 8 also provides additional details regarding networks, such as the network 260 shown. While FIG. 2 shows example arrangements and configurations of the image generation system and associated components, other arrangements and configurations are possible.

As shown, the server device 202 includes a content management system 204 and an image generation system 206. In various implementations, the content management system 204 performs a variety of functions, such as providing access to content including text documents. In various implementations, the content management system 204 is a computer application for creating, editing, consuming, and/or removing digital content.

The server device 202 also includes the image generation system 206. In one or more implementations, the server device 202 and/or the content management system 204 include all or a portion of the image generation system 206. For instance, the image generation system 206 is located on a different device than the content management system 204. In some implementations, some or all of the image generation system 206 resides on a client device, such as the client device 250. For example, the client device 250 downloads and/or accesses an application from the server device 202 (e.g., one or more models of the image generation system 206) or a portion of a software application.

As shown, the image generation system 206 includes various components and elements. For example, the image generation system 206 includes a text document manager 210 that manages text documents. The text document manager 210 operates in connection with the content management system 204 to access text documents, then ingests and analyzes them to determine entities, corresponding entity identifiers, semantic text chunks, and/or re-written semantic text chunks.

In various implementations, the text document manager 210 utilizes various models. For example, the text document manager 210 utilizes an entity recognition model 222 to generate a set of entities 234 and a set of entity identifiers 232, a semantic text chunking model 224 to generate a set of semantic text chunks 236, and a semantic text recharacterization model 226 to generate re-written semantic text chunks (which can be included in the set of semantic text chunks 236).

Additionally, the image generation system 206 includes an image generation manager 212 that generates synthetic images. For example, the image generation manager 212 utilizes an image generation model 228 to generate a set of synthetic images 238. Further, in one or more implementations, the image generation manager 212 utilizes a visual embedding extraction model 230 to generate visual entity embeddings 240 for entities within synthetic images. The image generation manager 212 then uses the visual entity embeddings 240 to more efficiently and accurately generate synthetic images in the set of synthetic images 238.

As shown, the image generation system 206 also includes a user interface manager 214 that implements interface elements and features within the text document. For example, the user interface manager 214 determines where to place synthetic images within the text document. The user interface manager 214 also implements user interaction features that allow users to influence the generation of the synthetic images, including requesting a particular style, adding another synthetic image, or regenerating the set of synthetic images 238.

The image generation system 206 also includes a storage manager 216 that stores various pieces of data and models 220 corresponding to the image generation system 206. In some instances, the storage manager 216 includes an entity table or database for the set of entities 234 indexed by their corresponding set of entity identifiers 232. The set of entity identifiers 232 can also include the visual entity embeddings 240, where available. In some implementations, the visual entity embeddings 240 are stored separately, such as in a visual entity embeddings table or database linked to a corresponding set of entity identifiers 232.

In various implementations, the client device 250 is associated with a user (e.g., a user client device), such as a user who interacts with the image generation system 206 to access and view synthetic images within a text document. As shown, the client device 250 includes a client application 252 with a text document 254. For example, the client application 252 could be a web browser, word processing software, or another type of computer application that displays the text document 254.

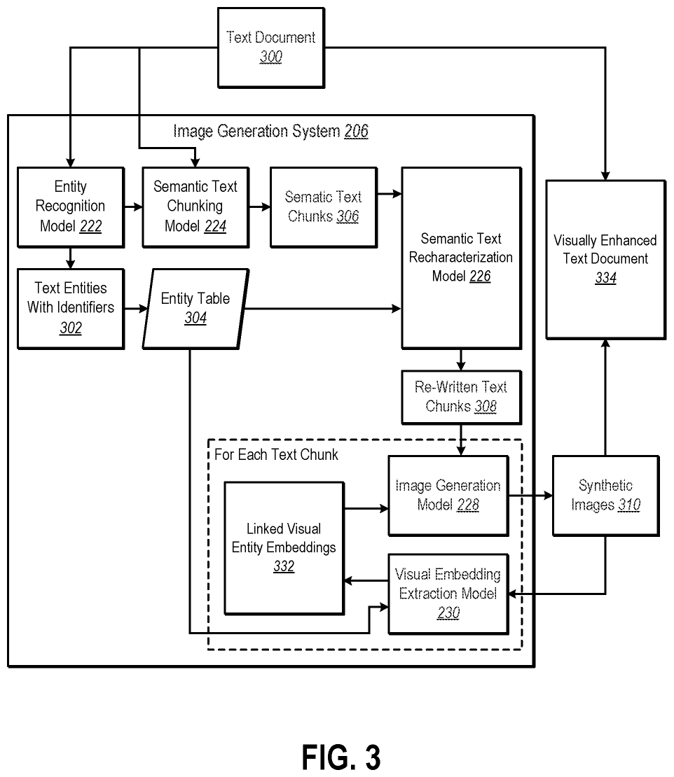

FIG. 3 illustrates an example block diagram of various components of the image generation system according to some implementations. In particular, FIG. 3 provides additional detail regarding interactions between different components of the image generation system 206, including various models that were introduced above. Utilizing the various models, the image generation system 206 generates synthetic images 310 to enrich a text document 300, resulting in a visually enhanced text document 334.

The image generation system 206 includes various models, such as the entity recognition model 222, the semantic text chunking model 224, the semantic text recharacterization model 226, the image generation model 228, and the visual embedding extraction model 230. As shown, the image generation system 206 also includes an entity table 304, which was discussed above.

In various implementations, the image generation system 206 generates text entities with identifiers 302 utilizing an entity detection model, such as the entity recognition model 222. For example, the entity recognition model 222 is a machine-learning model, such as a long short-term memory (LSTM) network (e.g., a type of recurrent neural network (RNN)), a transformer based model, or another deep-learning model capable of learning long-term dependencies between entities. In various instances, the entity recognition model 222 receives the entire text document 300 as input and outputs the text entities with identifiers 302. In various implementations, the entity recognition model 222 also determines sub-entities for a determined entity.

As shown, the image generation system 206 stores the text entities with identifiers 302 in the entity table 304. As mentioned, entities can include people, characters, objects, concepts, and places that are identified and extracted from the text document 300 before being stored within the entity table 304. Further, the entity table 304 may associate entities with their corresponding sub-entities in the entity table 304, such as characteristics and attributes of an entity. Each entity and/or sub-entity may be uniquely identified by an entity identifier.

Additionally, as shown, the image generation system 206 generates semantic text chunks 306 utilizing the semantic text chunking model 224. For example, the semantic text chunking model 224 is a machine-learning model or a heuristic-based model and/or algorithm that determines contextual breaks or pauses within the text document 300. For instance, the semantic text chunking model 224 ingests the identifiers 302 and groups portions according to a contextual mapping. Then, when two adjacent portions (e.g., lines, sentences, paragraphs, pages, sections, or chapters) are separated beyond a semantic threshold distance, the semantic text chunking model 224 creates a semantic text chunk. In some implementations, the semantic text chunking model 224 generates semantic text chunks 306 based on a predetermined number of text portions.

As shown, the image generation system 206 generates re-written text chunks 308 utilizing the semantic text recharacterization model 226. The semantic text recharacterization model 226 includes one or more models (machine-learning and/or heuristic-based models) that process or digest the semantic text chunks 306 to generate the re-written text chunks 308. For example, the image generation model 228 is a semantic recharacterization machine-learning model that is trained to output recharacterized text chunks that remove non-contextual information. In various implementations, the image generation model 228 is a generative language model, such as a large language model (LLM), which can regenerate and optimize the semantic text chunks 306 as inputs to downstream models. In some implementations, the semantic text recharacterization model 226 follows a set of rules (e.g., non-advanced lexicon rules) that include removing and/or rewriting words and phrases.

In various implementations, the semantic text recharacterization model 226 performs co-reference resolution for identified entities. For example, the semantic text recharacterization model 226 removes pronouns and/or links all mentions of the same entity (e.g., person, place, or thing) within a text.

Along these lines, the semantic text recharacterization model 226 incorporates the identifiers of the text entities (e.g., the text entities with identifiers 302) with instances of the entities from within each of the semantic text chunks 306. For instance, when the person “John” appears in any text chunk referring to the same character, the word is tagged with the same entity identifier for John. In some instances, the word “John” is also replaced with a general description, such as person, man, or main character. In some implementations, the entity identifier links to information and/or metadata about the entity, which may be passed from the entity table 304 to downstream models, such as the semantic text recharacterization model 226 and/or image generation model 228.

As an example, the semantic text recharacterization model 226 may receive the text chunk of “Bob enters into his office and sits on his desk chair.” In response, the semantic text recharacterization model 226 processes the input and outputs a re-written text chunk of “Person [Bob's ID]> sits on an “Object-Table <Chair ID>.” As shown, the semantic text recharacterization model 226 replaces entities within the text chunk, removes pronouns, and omits non-contextual information.

As mentioned above, the semantic text recharacterization model 226 may also add an identifier to an entity for a sub-entity. For example, if John is happy in one text chunk, the semantic text recharacterization model 226 adds the entity identifier for John followed by the sub-entity identifier for John-happy. Then, when John is mentioned in another text chunk without an associated emotion, the semantic text recharacterization model 226 omits an identifier for a sub-entity to signal or indicate a different appearance of John when generating a distinct synthetic image. Similarly, if the semantic text recharacterization model 226 added the sub-entity identifier for John-crying, the semantic text recharacterization model 226 is signaling to the image generation model 228 in the re-written text chunk 308 to portray the same person, John, but with the action of crying rather than being happy.

As mentioned above, the image generation system 206 includes the image generation model 228 and the visual embedding extraction model 230. As shown, for each text chunk, the image generation system 206 generates a synthetic image. In some implementations, the image generation system 206 determines not to generate a synthetic image for a text chunk or multiple synthetic images for a text chunk. In some implementations, the image generation system 206 determines the number of synthetic images to generate for the identifiers 302 based on user input, preferences, or default settings.

In various implementations, the image generation system is a machine-learning model and/or neural network that generates the synthetic images 310 based on one or more inputs. For example, the image generation model 228 is a generative adversarial network (GAN). The image generation model 228 may be another type of generative deep-learning model trained to generate synthetic images from text-based inputs, entity identifiers, entity metadata, and/or visual entity embeddings.

In some implementations, the image generation model 228 generates the synthetic images 310 based on user input. In one example, the image generation system 206 receives user input specifying a style or theme of the synthetic images 310, which the image generation system 206 sets as a constant parameter of the image generation model 228 when generating the synthetic images 310 for the text document 300. In another example, the user directly or indirectly provides input of an image to be followed or matched in generating the synthetic images 310. For instance, a length text document includes a limited number of images, which are provided to the image generation model 228 as input to generate artistically similar synthetic images.

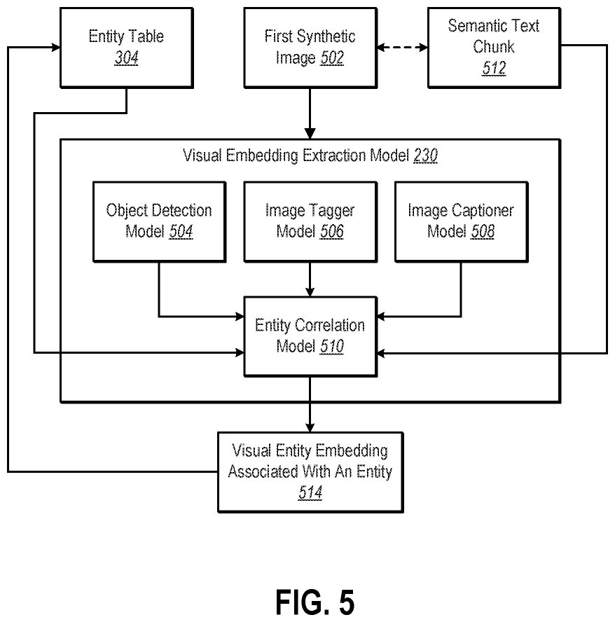

As shown, the image generation system 206 generates and links visual entity embeddings from entities within the synthetic images 310 to entity identifiers from the entity table 304, which is represented as the linked visual entity embeddings 332. In various implementations, the image generation system 206 utilizes the visual embedding extraction model 230 to generate visual entity embeddings for entities and/or determine how an object within a synthetic image (having a visual embedding) is linked to an entity identifier. Additional details regarding this process are provided below in connection with FIG. 5.

As also shown, the image generation system 206 again utilizes the image generation model 228 to generate the synthetic images 310. When a visual entity embedding is available for an entity identifier included in a subsequent text chunk, the image generation system 206 provides the corresponding visual entity embeddings to the image generation model 228 along with the subsequent text chunk. In addition, the image generation system 206 may also provide previously generated synthetic images along with their metadata and/or visual embeddings when the image generation model 228 is generating synthetic images for text chunks that include previously seen entity identifiers. This process improves the efficiency of the image generation model 228 as it can reuse a visual entity embedding instead of regenerating them each time they appear in a text chunk. By reusing a visual entity embedding, the different instances of the same entity will match in style and appearance.

In some instances, the image generation model 228 regenerates earlier synthetic images within a set of synthetic images to ensure that previous and later images consistently and continuously match throughout the set. As mentioned below, each time an entity is generated within a synthetic image, the image generation system 206 can add, update, replace, or combine the visual entity embeddings to the entity within the entity table 304.

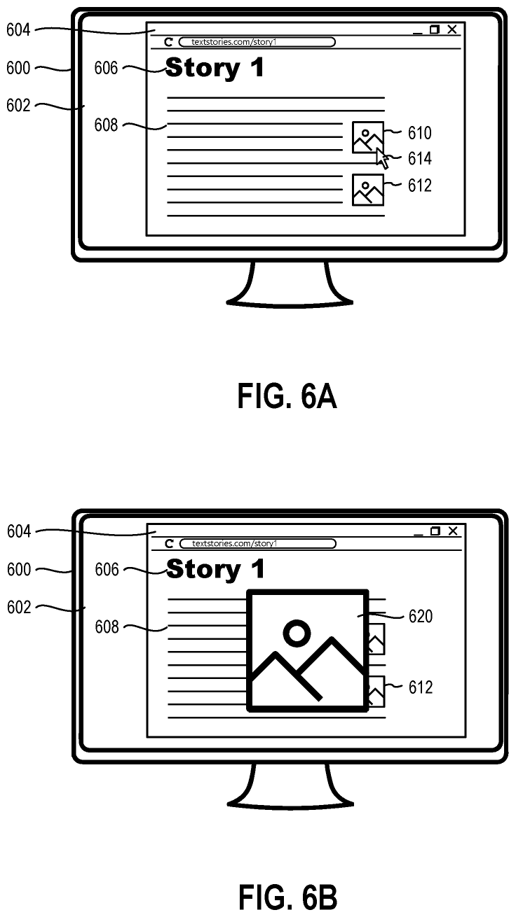

As shown, upon generating the synthetic images 310, the image generation system 206 combines them with the entity identifiers to generate the visually enhanced text document 334. The visually enhanced text document 334 includes the synthetic images 310 inline or as pop-up options for a user as they view the text document now having a set of consistent, continuous, and matching images at key points within the document. In various implementations, the image generation system 206 performs scene-to-image mapping, which is further described below in connection with FIGS. 6A-6B.

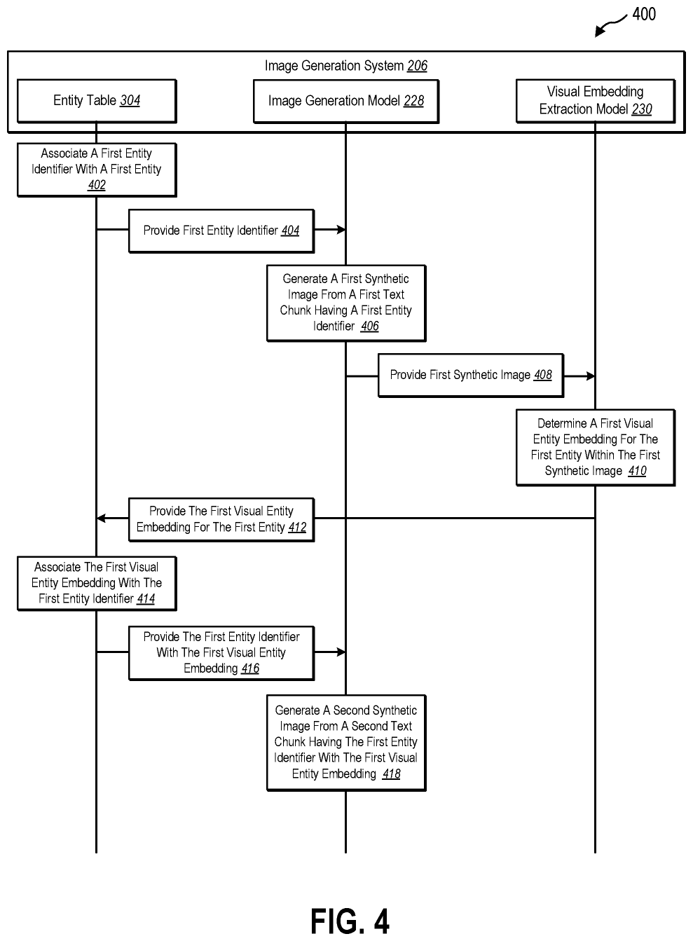

Turning to FIG. 4, this figure illustrates a sequence flow diagram example of a series of contextually-persistent visual images for a text document according to some implementations. In particular, FIG. 4 shows a series of acts 400 performed by various components of the image generation system 206 to generate a set of contextually-persistent visual images for a text document. As shown in FIG. 4, the image generation system 206 includes the entity table 304, the image generation model 228, and the visual embedding extraction model 230, which were previously introduced.

As shown, the series of acts 400 begins with the act 402 of associating a first entity identifier with a first entity. In particular, the image generation system 206 associates a first entity identifier with a first entity within the entity table 304. In various implementations, this includes adding the first entity to the entity table 304 and assigning it a unique entity identifier, which can serve as an index for the first entity. It may also include adding metadata and/or other information (e.g., characteristics, attributes, contextual data) to the entity table 304 in connection with the first entity.

In some instances, if the first entity is already in the entity table 304, the image generation system 206 may add additional metadata and/or other information to its entry associated with the entity identifier. The image generation system 206 may also add sub-entities that highlight key attributes and/or characteristics of the first entity. This way, as the image generation system 206 ingests and processes the text document, the image generation system 206 can generate and store a complete representation of the first entity, including points within the text document where the entity changes.

The series of acts 400 also includes the act 404 of providing the first entity identifier to the image generation model 228. For example, the image generation system 206 provides the first entity identifier to the image generation model 228 within a semantic text chunk. In various implementations, the image generation model 228 uses the first entity identifier to access metadata and/or information about the first entity from the entity table 304 to better visualize it within a synthetic image. By storing relevant information about an entity in the entity table 304 for the whole text document, the image generation system 206 visually renders an entity accurately from its first mention, even though additional contextual information about the entity is not provided until later in the text document. This also allows the image generation system 206 to consistently render the entity throughout the series of synthetic images and accurately depict when changes to the entity occur.

As shown, the act 406 includes the image generation model 228 generating a first synthetic image from a first text chunk having a first entity identifier. As mentioned above, the image generation model 228 may be a generative model that creates or generates synthetic images based on receiving text inputs (e.g., text chunks with entity identifiers), entity data and metadata, and visual entity embeddings in some cases. As also shown, the act 408 includes the image generation model 228 providing the first synthetic image to the visual embedding extraction model 230.

In the act 410, the visual embedding extraction model 230 determines a first visual entity embedding for the first entity within the first synthetic image. As further described below in FIG. 5, the image generation system 206 identifies visual entity embeddings within synthetic images and/or links the visual entity embeddings with entity identifiers. For instance, the visual embedding extraction model 230 identifies multiple visual entity embeddings within the first synthetic image and determines which of those embeddings corresponds to the first entity.

As shown, the act 412 includes providing the first visual entity embedding to the entity table 304 and the act 414 includes associating the first visual entity embedding with the first entity identifier within the entity table 304. For instance, the image generation system 206 stores the first visual entity embedding (e.g., a string of numbers or structured data) with the first entity in the entity table 304. Later, when a component or model accesses the entity table 304 in a request that includes the first entity identifier, the image generation system 206 can return information about the first entity along with its first visual entity embedding.

In one or more implementations, the image generation system 206 stores multiple instances of the first visual entity embedding for the first entity. For example, each time a synthetic image includes a rendering of the first entity, the image generation system 206 stores its version or instance of the first visual entity embedding within the entity table 304, associated with the first entity identifier. In some implementations, the image generation system 206 combines the multiple instances of the first visual entity embedding, while in other implementations, the image generation system 206 stores one or more of the multiple instances individually.

In some implementations, the acts 410-414 occur differently than illustrated. For instance, the entity table 304 provides entity identifiers to the visual embedding extraction model 230 to assist it in determining a correlation between the first visual entity embedding and the first entity. In some implementations, the image generation model 228 provides the first entity identifier to the visual embedding extraction model 230 along with the first synthetic image. The image generation system 206 may employ other methods to communicate the entity identifiers to the visual embedding extraction model 230.

Upon associating the first visual entity embedding with the first entity identifier within the entity table 304, the image generation system 206 provides the first entity identifier with the first visual entity embedding to the image generation model 228, as shown in the act 416. In some implementations, the first visual entity embedding is provided in response to a request from the image generation model 228 for information regarding the first entity and/or whether a first visual entity embedding exists for the first entity identifier (or the image generation system 206 obtains it from the entity table 304 as an input to the visual embedding extraction model 230 when also providing a text chunk that includes the first entity identifier).

In the act 418, the image generation model 228 generates a second synthetic image from a second text chunk having the first entity identifier with the first visual entity embedding. In these instances, the image generation model 228 utilizes the one or more first visual entity embeddings to depict the first entity in the second synthetic image within the context laid out in the second text chunk. As noted above, the semantic text recharacterization model 226 operates more efficiently and generates more accurate and consistent depictions of entities when using previously created visual embeddings as a template.

In some instances, the semantic text recharacterization model 226 utilizes one or more visual embeddings for sub-entities of the first entity. The semantic text recharacterization model 226 may use the visual embedding of a sub-entity to match or distinguish the look of the first entity in a subsequent synthetic image depending on how similarly the entity is characterized in the current text chunk being rendered compared to a previously rendered text chunk. For example, if a person was initially happy in a first text chunk, ecstatic in a second text chunk, but sad in a third text chunk, the image generation model 228 utilizes each of the visual embeddings to determine how and to what extent to modify the appearance or look of the person in the set of synthetic images.

The series of acts 400 may repeat the acts 410-418 for each subsequent synthetic image. For example, the image generation system 206 builds up the entity table 304 to include visual entity embeddings for many, most, or all of the stored entity identifiers. As more visual entity embeddings are added, the image generation model 228 can become more efficient in matching and visually depicting entities in the set of synthetic images.

FIG. 5 illustrates a block diagram example of determining a visual entity embedding from a synthetic image. In particular, FIG. 5 describes various approaches of the image generation system 206 to determine and associate visual entity embeddings from synthetic images with entity identifiers that were used to generate the synthetic images. This way, the image generation system 206 may reuse the visual entity embedding to efficiently and accurately depict the same entities in future synthetic images.

As shown, FIG. 5 includes the visual embedding extraction model 230 and the entity table 304, which were previously introduced. In addition, FIG. 5 includes a first synthetic image 502, a semantic text chunk 512 that corresponds to the first synthetic image 502, and an entity-associated visual entity embedding 514 (including sub-entities). Additionally, the visual embedding extraction model 230 includes various models or components, such as an object detection model 504, an image tagger model 506, an image captioner model 508, and an entity correlation model 510. While multiple models are shown, the visual embedding extraction model 230 may include additional, different, combined, or fewer models.

To illustrate, the image generation system 206 provides the first synthetic image 502 to the visual embedding extraction model 230. In some implementations, the image generation system 206 also provides the entity table 304 and/or the semantic text chunk 512 to the visual embedding extraction model 230. In response, the visual embedding extraction model 230 generates the entity-associated visual entity embedding 514.

In one or more implementations, the visual embedding extraction model 230 utilizes the object detection model 504 on the first synthetic image 502. For example, the object detection model 504 determines objects within the first synthetic image 502 that represent potential entities. In some implementations, the object detection model 504 is a machine-learning model or neural network that isolates identified and/or detected objects within the first synthetic image 502. In various implementations, the object detection model 504 utilizes the semantic text chunk 512 and/or entity table 304 to identify entities within the image and detect corresponding objects.

In some implementations, the object detection model 504 generates a visual embedding of a detected object. For example, the object detection model 504 isolates a detected object and processes its pixels to generate a corresponding visual embedding.

In various implementations, the visual embedding extraction model 230 utilizes the image tagger model 506. For instance, for detected objects, the image tagger model 506 classifies labels or tags for the objects, which may include characteristics or attributes of the objects. Similarly, the image captioner model 508 may generate a caption or summary for the first synthetic image 502 based on analyzing its visual content.

In various implementations, the entity correlation model 510 determines correlations between entities within the first synthetic image 502 and the outputs of the models discussed above. For example, the entity correlation model 510 works with the object detection model 504 to detect a person or object within the first synthetic image 502 determined from an entity identifier within the semantic text chunk 512, as mentioned earlier. As another example, the entity correlation model 510 correlates the tags and/or captions with the semantic text chunk 512 to determine which entity identifiers in the text chunk align with objects detected in the first synthetic image 502. The entity correlation model 510 determines a match when an entity similarity threshold is satisfied.

Once the visual embedding extraction model 230 determines the entity-associated visual entity embedding 514, the image generation system 206 adds the visual embedding to the entity table 304 as a visual entity embedding associated with an entity identifier. For instance, the entry for Person A in the entity table 304 will also have their entity identifier represented by a vector space embedding.

Similarly, sub-embeddings can have their own stored entity-associated visual entity embeddings that correspond to a specific version of their entity. For example, the entity table 304 includes a visual entity embedding for Person A (e.g., the main or parent entity), another visual entity embedding of Person A crying (e.g., a first sub-entity), and yet another visual entity embedding of Person A happy (e.g., a second sub-entity).

In some implementations, the visual embedding extraction model 230 is part of an image generation model. As noted above, the image generation model outputs synthetic images based on semantic text chunks and corresponding entity information. In some instances, the image generation model also provides visual entity embeddings for each entity generated within a synthetic image. This way, the image generation system 206 can automatically associate a visual entity embedding with its corresponding entity when the entity is visually depicted.

In some implementations, the entity correlation model 510 compares visual embeddings generated for a first synthetic image 502 with visual entity embeddings associated with entity identifiers included in the semantic text chunk 512. For example, the semantic text chunk 512 includes an entity identifier with a visual entity embedding stored within the entity table 304. The object detection model 504 (or another model) determines three visual embeddings for three detected objects. The entity correlation model 510 compares the visual entity embedding to the three visual embeddings to determine if they match within an entity similarity threshold (e.g., vector distance). If a match is found, the visual embedding extraction model 230 provides the new visual embedding to the entity table 304 to be associated with its corresponding entity identifier.

FIGS. 6A-6B illustrate graphical user interfaces for adding contextually-persistent synthetic images to a text document. As shown, FIGS. 6A-6B include a computing device 600, such as a user client device, having a graphical user interface 602 displaying a client application 604. For example, the client application 604 can be a web browser, word processing application, or another computer application that displays text documents.

As shown, the client application 604 includes a text document 606 of a story that includes sections of text 608. Additionally, the client application 604 includes a first image element 610 and a second image element 612 that are provided by the image generation system 206. That is, the first image element 610 and the second image element 612 are not originally present within the text document 606.

In various implementations, the image elements allow a user to interact with them to show synthetic images from a set of synthetic images generated for the text document 606 by the image generation system 206. For example, upon detecting a selection of the first image element 610 using a selection tool 614 (e.g., a computer mouse or finger), the image generation system 206 displays a synthetic image 620 within the client application 604, as shown in FIG. 6B. In some implementations, the user interaction includes hovering or another type of interaction with the first image element 610.

While the image elements are shown as icons in FIG. 6A, in some implementations, the image generation system 206 includes synthetic images in line with the text 608. The image generation system 206 may employ various techniques for displaying the set of synthetic images generated for the text document 606.

The image generation system 206 can use various approaches to map synthetic images (or their corresponding image elements) to different portions of a text document. For example, in some instances, the image generation system 206 determines the location of a synthetic image generated for a text chunk before or after the text chunk. In some instances, the image generation system 206 analyzes the text to identify or determine location changes, time jumps (e.g., a flashback, memory, or an advancement in time), and/or higher-level descriptions, including the introduction or reference of salient objects. Based on these changes, the image generation system 206 determines where to position or locate a corresponding synthetic image.

In some implementations, the image generation system 206 provides options or tools for a user to request new or additional synthetic images to be generated for a text document. For example, when the user is reading a passage without an image, the image generation system 206 generates an additional synthetic image in response to the user's request. Further, using the implementations described above, the newly generated image matches the style, appearance, and/or look of the other synthetic images in the series or set.

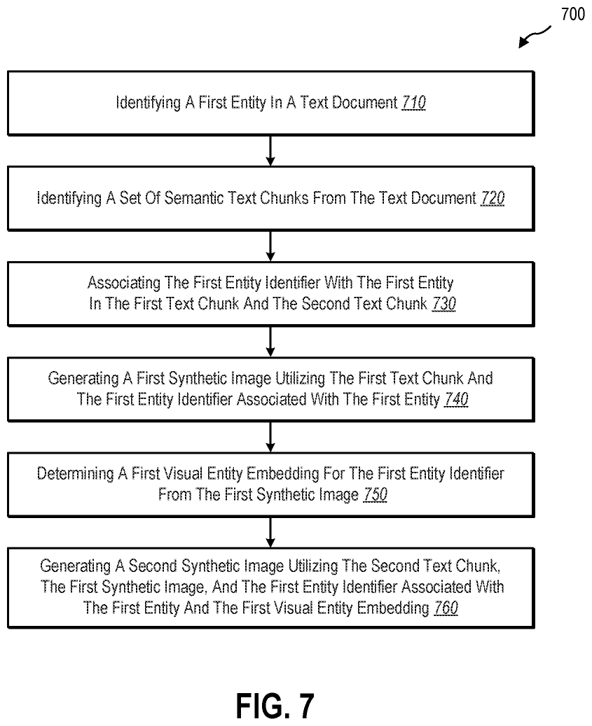

Turning now to FIG. 7, this figure illustrates an example flowchart that includes a series of acts for utilizing the image generation system 206 according to one or more implementations. In particular, FIG. 7 illustrates an example series of acts of computer-implemented methods for generating a series of contextually-persistent visual images for a text document utilizing multiple computer-based models.

While FIG. 7 illustrates acts according to one or more implementations, alternative implementations may omit, add, reorder, and/or modify any of the acts shown. Further, the acts of FIG. 7 can be performed as part of a method such as a computer-implemented method. Alternatively, a non-transitory computer-readable medium can include instructions that, when executed by a processor, cause a computing device to perform the acts of FIG. 7.

In further implementations, a system can perform (e.g., a processing system with a processor can cause instructions to be performed) the acts of FIG. 7. For example, the system includes computer-based models including an entity recognition model, a semantic text chunking model, an image generation model, and a visual entity embedding extraction model. In some implementations, the system includes a processing system including a processor and computer memory including instructions that, when executed by the processing system, cause the system to perform various operations.

As shown, the series of acts 700 includes an act 710 of identifying a first entity in a text document. For example, the act 710 involves generating a first entity identifier for a first entity identified in a text document. In various implementations, the act 710 includes generating a first entity identifier for a first entity identified in a text document utilizing the entity recognition model. In some implementations, this act includes generating a set of entity identifiers for a set of entities identified in a text document.

In some implementations, this act includes generating a set of entity identifiers, including the first entity identifier from the text document utilizing an entity recognition model, where the set of entity identifiers correspond to people, objects, and/or places within the text document, and where the first entity identifier is associated with a sub-entity identifier corresponding to a characteristic or attribute of the first entity.

As further shown, the series of acts 700 includes an act 720 of separating the text document into a set of chunks. For instance, in example implementations, the act 720 involves identifying a set of semantic text chunks from the text document including a first text chunk and a second text chunk. In various implementations, the act 720 includes separating the text document into a set of semantic text chunks, including a first text chunk and a second text chunk, utilizing the semantic text chunking model. In some implementations, this act includes separating the text document into a set of semantic text chunks. In some implementations, this act includes generating the set of semantic text chunks from the text document utilizing a semantic text chunking model that determines how to separate portions of the text document based on semantic differences.

As further shown, the series of acts 700 includes an act 730 of associating the first entity identifier with the first entity in the first text chunk and the second text chunk. For instance, in example implementations, the act 730 involves associating the first entity identifier with a first instance of the first entity within the first text chunk and with a second instance of the first entity within the second text chunk. In various implementations, the act 730 includes associating the first entity identifier with a first instance of the first entity within the first text chunk and with a second instance of the first entity within the second text chunk. In some implementations, this act includes associating the set of entity identifiers with the set of semantic text chunks. In some implementations, this act includes re-writing the first text chunk utilizing a semantic text recharacterization model to mark entities with corresponding entity identifiers, resolving co-reference terms, and removing non-contextual information.

As further shown, the series of acts 700 includes an act 740 of generating a first synthetic image utilizing the first text chunk and the first entity identifier. For instance, in example implementations, the act 740 involves generating a first synthetic image utilizing the first text chunk and the first entity identifier associated with the first entity. In various implementations, the act 740 includes generating a first synthetic image utilizing the first text chunk and the first entity identifier associated with the first entity using the image generation model. In some implementations, this act includes generating the first synthetic image using an image generation model based on the first text chunk and the first entity identifier associated with the first entity.

As further shown, the series of acts 700 includes an act 750 of determining a first visual entity embedding for the first entity from the first synthetic image. For instance, in example implementations, the act 750 involves determining a first visual entity embedding for the first entity identifier from the first synthetic image. In various implementations, the act 750 includes determining a first visual entity embedding for the first entity identifier from the first synthetic image using the visual entity embedding extraction model. In some implementations, this act includes using a visual entity embedding extraction model that generates visual entity embeddings for entities detected in digital images.

In various implementations, the act 750 act includes determining the first visual entity embedding from the first synthetic image based on receiving the first visual entity embedding extracted as an output from the image generation model in connection with receiving the first synthetic image. In one or more implementations, the act 750 act includes associating the first visual entity embedding with the first entity identifier in an entity table. In one or more implementations, the act 750 act includes generating tag candidate entities in the first synthetic image, generating a first image caption from the first synthetic image, comparing the first image caption to the first text chunk to determine a correlation between a first tag candidate entity and the first entity, and associating the first visual entity embedding generated for the first tag candidate entity with the first entity identifier.

As further shown, the series of acts 700 includes an act 760 of generating a second synthetic image utilizing the second text chunk and the first visual entity embedding. For instance, in example implementations, the act 760 involves generating a second synthetic image utilizing the second text chunk, the first synthetic image, and the first entity identifier associated with the first entity and the first visual entity embedding. In some instances, the first entity in the first synthetic image matches the first entity in the second synthetic image. In various implementations, the act 760 includes generating a second synthetic image utilizing the second text chunk, the first synthetic image, and the first entity identifier associated with the first entity and the first visual entity embedding using the image generation model. In some implementations, this act includes, for a text chunk of the set of semantic text chunks, generating a synthetic image utilizing the text chunk, one or more entity identifiers associated with entities in the text chunk, and visual entity embeddings associated with the entities in the text chunk.

In some instances, the first entity in the first synthetic image is continuous with the first entity in the second synthetic image. In various instances, this act includes utilizing an image tagging model to determine the first visual entity embedding of the first entity identifier within the first synthetic image and/or utilizing an image captioner model to generate a caption of the first synthetic image and determine the first visual entity embedding of the first entity identifier within the first synthetic image.

In some implementations, this act includes generating the second synthetic image using the image generation model based on the second text chunk, the first synthetic image, and the first entity identifier, where the first entity identifier includes the first entity and the first visual entity embedding. In one or more implementations, a first instance of a person in the first synthetic image associated with the first entity identifier is continuous with a second instance of the person in the second synthetic image based on the image generation model using the first visual entity embedding from the first synthetic image when generating the second instance of the person in the second synthetic image.

In some implementations, the series of acts 700 includes additional acts. For example, the series of acts 700 includes acts of the series of acts 700 includes providing, throughout the text document, a set of synthetic images having a common artistic style and entity continuity. In various implementations, the series of acts 700 includes providing the first synthetic image in the first location of the text document corresponding to the first text chunk and/or providing the second synthetic image in the second location of the text document corresponding to the second text chunk.

In some implementations, the series of acts 700 includes analyzing the text document for semantic changes that satisfy an image location threshold to determine where in the text document to place synthetic images. Additionally, in one or more implementations, the series of acts 700 includes providing a user interface element with a passage of the text document to request a synthetic image of the passage, where the synthetic image is previously generated or is generated on-the-fly in response to detecting a selection of a request.

FIG. 8 illustrates certain components that may be included within a computer system 800. The computer system 800 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 800 represents one or more of the client devices, server devices, or other computing devices described above. For example, the computer system 800 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 800 includes a processing system including a processor 801. The processor 801 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 801 may be referred to as a central processing unit (CPU) and may cause computer-implemented instructions to be performed. Although the processor 801 shown is just a single processor in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 805 and the data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during the execution of the instructions 805 by the processor 801.

A computer system 800 may also include one or more communication interface(s) 809 for communicating with other electronic devices. The one or more communication interface(s) 809 may be based on wired communication technology, wireless communication technology, or both. Some examples of the one or more communication interface(s) 809 include a Universal Serial Bus (USB), an Ethernet adapter, a wireless adapter that operates according to an Institute of Electrical and Electronics Engineers (IEEE) 802.11 wireless communication protocol, a Bluetooth® wireless communication adapter, and an infrared (IR) communication port.

A computer system 800 may also include one or more input device(s) 811 and one or more output device(s) 813. Some examples of the one or more input device(s) 811 include a keyboard, mouse, microphone, remote control device, button, joystick, trackball, touchpad, and light pen. Some examples of the one or more output device(s) 813 include a speaker and a printer. A specific type of output device that is typically included in a computer system 800 is a display device 815. The display device 815 used with implementations disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For clarity, the various buses are illustrated in FIG. 8 as a bus system 819.

This disclosure describes an image generation system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for generating contextually-persistent images across a text document, comprising:
generating a first entity identifier for a first entity identified in the text document;
identifying a set of semantic text chunks from the text document including a first text chunk and a second text chunk;
associating the first entity identifier with a first instance of the first entity within the first text chunk and with a second instance of the first entity within the second text chunk;
generating a first synthetic image utilizing the first text chunk and the first entity identifier associated with the first entity;
determining a first visual entity embedding for the first entity identifier from the first synthetic image; and
generating a second synthetic image utilizing the second text chunk, the first synthetic image, and the first entity identifier associated with the first entity and the first visual entity embedding, wherein the first entity in the first synthetic image matches the first entity in the second synthetic image.

2. The computer-implemented method of claim 1, further comprising generating a set of entity identifiers including the first entity identifier from the text document utilizing an entity recognition model, wherein the set of entity identifiers correspond to people, objects, or places within the text document, and wherein the first entity identifier is associated with a sub-entity identifier corresponding to a characteristic or attribute of the first entity.

3. The computer-implemented method of claim 2, further comprising generating the set of semantic text chunks from the text document utilizing a semantic text chunking model that determines how to separate portions of the text document based on semantic differences.

4. The computer-implemented method of claim 3, further comprising re-writing the first text chunk utilizing a semantic text recharacterization model to mark entities with corresponding entity identifiers, resolving co-reference terms, and removing non-contextual information.

5. The computer-implemented method of claim 4, further comprising generating the first synthetic image using an image generation model based on the first text chunk and the first entity identifier associated with the first entity.

6. The computer-implemented method of claim 1 further comprising associating the first visual entity embedding with the first entity identifier in an entity table.

7. The computer-implemented method of claim 1, further comprising determining the first visual entity embedding from the first synthetic image using a visual entity embedding extraction model that generates visual entity embeddings for entities detected in digital images.

8. The computer-implemented method of claim 6, further comprising generating the second synthetic image using an image generation model based on the second text chunk, the first synthetic image, and the first entity identifier, wherein the first entity identifier includes the first entity and the first visual entity embedding.

9. The computer-implemented method of claim 8, wherein a first instance of a person in the first synthetic image associated with the first entity identifier is continuous with a second instance of the person in the second synthetic image based on an image generation model using the first visual entity embedding from the first synthetic image when generating the second instance of the person in the second synthetic image.

10. The computer-implemented method of claim 1, further comprising determining the first visual entity embedding from the first synthetic image based on receiving the first visual entity embedding extracted as an output from an image generation model in connection with receiving the first synthetic image.

11. The computer-implemented method of claim 1, further comprising determining the first visual entity embedding from the first synthetic image by:
generating tag candidate entities in the first synthetic image;
generating a first image caption from the first synthetic image;
comparing the first image caption to the first text chunk to determine a correlation between a first tag candidate entity and the first entity; and
associating the first visual entity embedding generated for the first tag candidate entity with the first entity identifier.

12. The computer-implemented method of claim 1, further comprising:
providing the first synthetic image in a first location of the text document corresponding to the first text chunk; and
providing the second synthetic image in a second location of the text document corresponding to the second text chunk.

13. The computer-implemented method of claim 1, further comprising analyzing the text document for semantic changes that satisfy an image location threshold to determine where in the text document to place synthetic images.

14. The computer-implemented method of claim 1, further comprising providing a user interface element with a passage of the text document to request a synthetic image of the passage, wherein the synthetic image is previously generated or is generated on-the-fly in response to detecting a selection of a request.

15. A system for generating contextually-persistent images across a text document, comprising:
computer-based models including an entity recognition model, a semantic text chunking model, an image generation model, and a visual entity embedding extraction model;
a processing system comprising a processor; and
a computer memory comprising instructions that, when executed by the processing system, cause the system to perform operations comprising:
generating a first entity identifier for a first entity identified in the text document utilizing the entity recognition model;
identifying a set of semantic text chunks from the text document including a first text chunk and a second text chunk utilizing the semantic text chunking model;
associating the first entity identifier with a first instance of the first entity within the first text chunk and with a second instance of the first entity within the second text chunk;
generating a first synthetic image utilizing the first text chunk and the first entity identifier associated with the first entity using the image generation model;
determining a first visual entity embedding for the first entity identifier from the first synthetic image using the visual entity embedding extraction model; and
generating a second synthetic image utilizing the second text chunk, the first synthetic image, and the first entity identifier associated with the first entity and the first visual entity embedding using the image generation model, wherein the first entity in the first synthetic image is continuous with the first entity in the second synthetic image.

16. The system of claim 15, wherein the operations further include utilizing an image tagging model to determine the first visual entity embedding of the first entity identifier within the first synthetic image.

17. The system of claim 15, wherein the operations further include utilizing an image captioner model to generate a caption of the first synthetic image and determine the first visual entity embedding of the first entity identifier within the first synthetic image.

18. The system of claim 15, wherein the operations further include re-writing the set of semantic text chunks to resolve co-reference terms.

19. A computer-implemented method for generating contextually-persistent images across a text document, comprising:
generating a set of entity identifiers for a set of entities identified in the text document;
identifying a set of semantic text chunks from the text document;
associating the set of entity identifiers within the set of semantic text chunks;
for a text chunk of the set of semantic text chunks, generating a synthetic image utilizing the text chunk, one or more entity identifiers associated with entities in the text chunk, and visual entity embeddings associated with the entities in the text chunk; and
providing, throughout the text document, a set of synthetic images having a common artistic style and entity continuity.

20. The computer-implemented method of claim 19, further comprising associating a first visual entity embedding from the visual entity embeddings with a first entity from the set of entities and a first entity identifier from the set of entity identifiers in an entity table.
